(19) United States
(12) Patent Application Publication
(10) Pub. No.: US 2012/0259494 A1
(43) Pub. Date: Oct. 11, 2012

(54) Method and System for Coupling an Electric Machine to a Vehicle Running Gear, Especially for a Hybrid Vehicle

(75) Inventors: Eric Schaeffer, Paris (FR); Florian Galinaud, Paris (FR)

(73) Assignee: PEUGEOT CITROEN AUTOMOBILES SA, Velizy Villacoublay (FR)

(21) Appl. No.: 13/516,506

(22) PCT Filed: Dec. 6, 2010
(86) PCT No.: PCT/FR2010/052614

§ 371 Date: Jun. 15, 2012

(30) Foreign Application Priority Data
Dec. 17, 2009 (FR) 0959086

(51) Int. Cl. B60W 10/08; B60W 10/02

(52) U.S. Cl. 701/22; 477/12

(57) ABSTRACT

To couple an electric machine (42) with running-gear wheels (44) of a vehicle when the vehicle is running, the method comprises two steps activated in succession on the basis of a coupling request; a step of driving the electric machine (42) up to speed, in which a rotation rate command is applied to the electric machine (42) so as to reduce a déviation between the speed of an upstream dog clutch (51) rotating integrally with the electric machine and the speed of a downstream dog clutch (52) rotating integrally with the wheels (44); and an engagement step activated following a déviation (110) in speed that is below a predetermined threshold, in which the electric machine (42) is slaved to a torque command and the dog clutches (51, 52) are brought together until a state of positive interlock of the two dog clutches is obtained.

### CROSS-REFERENCE TO RELATED APPLICATIONS

This application is the US National Stage under 36 U.S.C. §371 of International App. No. PCT/FR2010/052614 filed Dec. 6, 2010, and which claims priority to French App. No. 0959086 filed Dec. 17, 2009.

### STATEMENT REGARDING FEDERALLY SPONSORED RESEARCH

Not Applicable.

### BACKGROUND

The invention relates to a method and a system for connecting an electrical machine to a drive axle of a vehicle, in particular a hybrid automotive vehicle, when the vehicle is moving.

The method and system are particularly suited for a hybrid vehicle which uses a combustion engine so as to make the electrical machine contribute to the traction of the vehicle.

Document FR2723553 discloses, for instance, an automotive vehicle comprising a selective command system for separate or simultaneous actuation of the electrical and thermal powertrains.

Document U.S. Pat. No. 5,403,244 discloses an electrical powertrain of a vehicle with direct transmission coupling, using a synchronization means based on friction plates similar to couplings with clutch plates. Clutch type couplings generate energy losses.

To increase the efficiency, the known state of technology is oriented towards dog clutch-type couplings. Document FR20905438 describes a control method employing two dog clutch couplers, whereby a force exercised in translation on one of the dog clutch couplers, in order to bring it closer to the other dog clutch coupler, is modulated according to different approach phases.

The present invention provides a simplified engagement, without a transmission clutch, and which does not require modulation of a force in translation, in particular when the vehicle is moving.

To achieve this goal, the invention provides a method for connecting an electrical machine with the wheels of the drive axle of a vehicle, when the vehicle is moving, comprising two successively activated steps starting with a coupling request:
a step of controlling the electrical machine, wherein a rotational speed instruction is applied to the electrical machine to reduce the gap between the speed of the upstream dog clutch coupler, which rotates together with the electrical machine, and the speed of the downstream dog clutch coupler, which rotates together with the wheels; and
a step of coupling which is activated following a speed gap smaller than a predetermined threshold, wherein the electrical machine is servo controlled based on a torque instruction and the dog clutch couplers are brought together until the dog clutch is in a coupled state.

In particular, the torque instruction is limited to an inertial torque compensation corresponding with the maximum potential acceleration of the vehicle.

More in particular, the speed instruction is based on a wheel speed value.

Advantageously, the coupling step activates when the speed gap is smaller than a predetermined threshold during a time delay.

The invention also provides a system for coupling an electrical machine with the wheels of a drive axle of a vehicle when the vehicle moves, comprising:
an upstream dog clutch coupler which rotates together with the electrical machine, a downstream dog clutch coupler which rotates together with the wheels and an actuator arranged for bringing the two dog clutch couplers closer together in translation along a common rotation axis; and
an electronic device arranged for receiving a engagement request, and for controlling the speed of the electrical machine by applying to it a rotational speed instruction in order to reduce the gap between the speed of the upstream dog clutch coupler and the speed of the downstream dog clutch coupler, and for servo controlling the electrical machine based on a torque instruction, and for bringing the dog clutch couplers together until the two dog clutch couplers are in connected state.

In particular, the torque instruction is limited to an inertial torque compensation corresponding with the maximum potential acceleration of the vehicle.

More in particular, the speed instruction is based on the wheel speed value.

Advantageously, the electronic device comprises a memorized time delay for verifying that the speed gap remains smaller than the predetermined threshold during said time.

The invention also provides an automotive vehicle comprising a system according to the invention.

### DESCRIPTION OF THE DRAWINGS

In the accompanying drawings which form part of the specification:

FIG. 1 is a schematic view of a hybrid automotive vehicle comprising a coupling system according to the invention;

FIG. 2 is a schematic view of the coupling system according to the invention; and

FIG. 3 shows the steps of the method according to the invention.

Corresponding reference numerals indicate corresponding parts throughout the several figures of the drawings.

### DETAILED DESCRIPTION

The following detailed description illustrates the claimed invention by way of example and not by way of limitation. The description clearly enables one skilled in the art to make and use the disclosure, describes several embodiments, adaptations, variations, alternatives, and uses of the disclosure, including what is presently believed to be the best mode of carrying out the claimed invention. Additionally, it is to be understood that the disclosure is not limited in its application to the details of construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting.

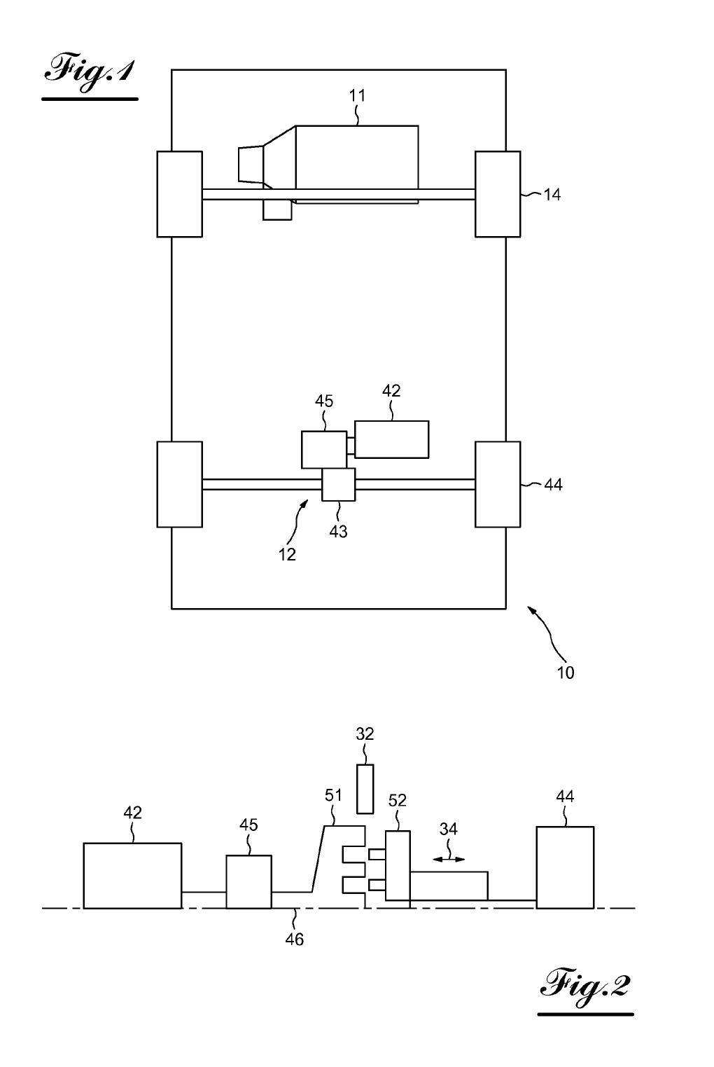

As shown in FIG. 1, a hybrid type vehicle 10 comprises a powertrain group 11 arranged for driving two front wheels 14 of vehicle 10, and a powertrain group 12 arranged for driving two rear wheels 44 belonging to the same rear axle of vehicle 10. The powertrain group (GMP) 11 comprises in known manner, a combustion engine located here strictly for illustrative purposes in the front of the vehicle. The powertrain group 12 comprises an electrical machine 42 connected to wheels 44 by a coupling mechanism 43.

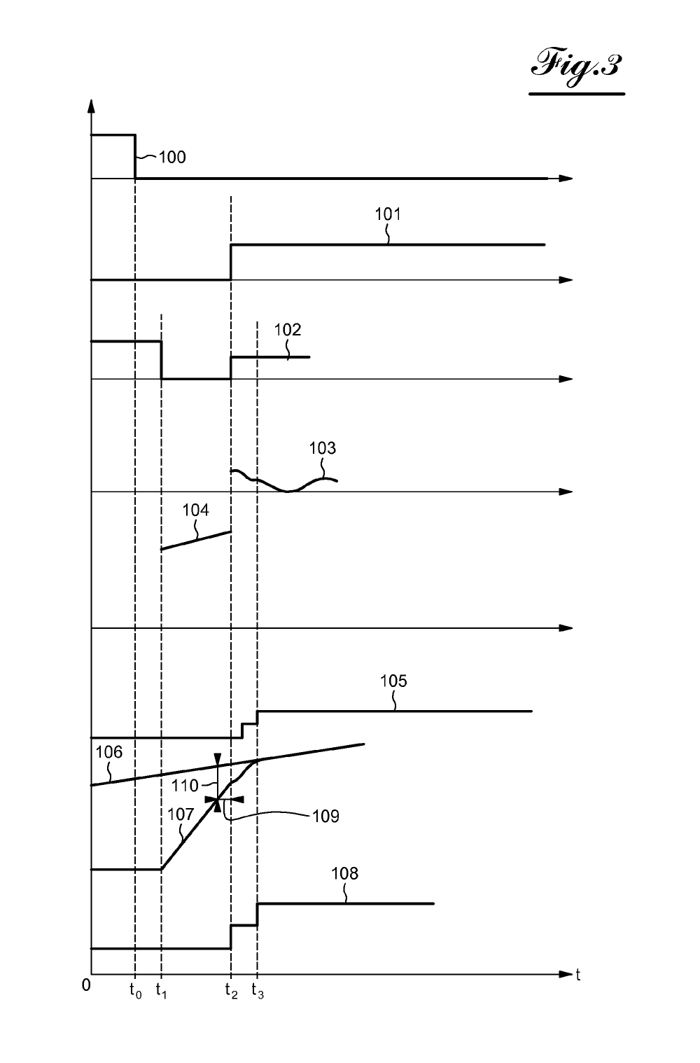

FIG. 2 shows in more detail the powertrain group 12 of FIG. 1. To lighten up the Figure and make it easier to understand, the axis of the electrical machine 42 and the axis of wheels 44 are schematically projected on the same axis 46, above which are simply represented the half parts of the electrical machine 42, coupling mechanism 43 and a square symbolizing the two wheels 44.

In the coupling mechanism 43, a dog clutch system comprises an upstream dog clutch coupler 51 and a downstream dog clutch coupler 52. The upstream dog clutch coupler 51 rotates together with a gear box, 45 which is connected to the output shaft of the electrical machine 42. The downstream dog clutch coupler 52 rotates together with wheels 44 via a differential mechanism, which balances in known manner, the torque between the wheels 44 of the rear axle, in particular when they spin at different speeds, for instance in a turn.

Dog clutch coupler 51 rotates around axis 46 at a rotational speed which is proportional or equal to the rotational speed of the electrical machine 42, and transmits a torque proportional to the torque generated by the electrical machine 42, while preserving the power supplied by the electrical machine 42 with an efficiency factor resulting from the transmission losses between the electrical machine 42 and the dog clutch coupler 51. The transmission losses in the electrical machine 42 and between the electrical machine 42 and the dog clutch coupler 51 can be represented by a drag torque of the part upstream of dog clutch coupler 51.

Dog clutch coupler 52 rotates around axis 46 at a rotational speed which is a function of the speed of wheels 44. A torque applied to dog clutch coupler 52 is transmitted to wheels 44. When the dog clutch coupler 52 is disengaged from dog clutch coupler 51, as shown in FIG. 2, the wheels 44 can turn or not turn, independently of the rotational speed of the electrical machine 42.

The coupling mechanism 43 comprises an actuator 34 arranged for displacing dog clutch coupler 52 in translation along the axis 46. The opposite faces of dog clutch couplers 51 and 52 are provided with teeth and cavities. The teeth of one dog clutch coupler are dimensioned so that they fit in the cavities of the other dog clutch coupler. In this way, when the teeth of dog clutch coupler 52 are facing the cavities of dog clutch coupler 51, as shown in FIG. 2, actuator 34 can engage dog clutch coupler 52 with dog clutch coupler 51 so that dog clutch couplers 51 and 52 are rotating together around axis 46. An on-or-off position sensor 32 mounts in the coupling mechanism 43 to detect the fully engaged position of dog clutch coupler 52 in dog clutch coupler 51.

Due to the independent rotation of dog clutch couplers 51 and 52, the teeth of dog clutch coupler 52 are not necessarily aligned with the cavities of dog clutch coupler 51 when actuator 34 displaces dog clutch coupler 52 in translation along axis 46. When the vehicle is in a driving situation, and coupling of the electrical machine is requested by the driver, it is difficult to quickly engage, without shock, the dog clutch couplers. The mechanical architecture of the rear powertrain group does not include a transmission clutch or a synchronizer. The only movement of the system is a translation of one of the dog clutch couplers 51, 52, exercised or activated by actuator 34. Statistically, engagement failures of dog clutch systems often occur due to a high probability of tooth-to-tooth contact between the dog clutch couplers before engagement of the dog clutch couplers.

To remedy this problem, the rear powertrain group comprises an electronic device which allows, as we will now explain, for precise torque control of the electrical machine 42 in combination with sequential control of the dog clutch actuator 34 in order to achieve rapid engagement without shocks which limits the number of failures or contacts between dog clutch teeth. The electronic device connects to actuator 34 and sensor 32 in the coupling mechanism 43. The electronic device connects also to the electrical machine 42 by a current regulated electrical generator. The electrical generator is, for instance, supplied in known manner starting from a battery, which is not shown. The electronic device comprises on the other hand electronic circuits for digital or analog processing arranged and/or programmed to execute the process steps which will be explained now with reference to FIG. 3.

To explain the process steps, FIG. 3 shows the status of the different signals in function of time.

Specifically, curve 100 represents the coupling request signal for a vehicle speed greater than or equal to 5 km/h. Up to time t₀ when a coupling request is received, the process is in an initial phase in which dog clutch couplers 51 and 52 are separated so that electrical machine 42 is disconnected from wheels 44. This state is represented by a high signal value on the curve 100, followed starting from time t₀ by a low signal value. It is understood that the high and low values are pure conventions and that the initial phase can also be represented by a low value of the signal followed beyond t0 by a high value.

Curve 101 represents a logic instruction of the position of actuator 34. In the initial phase of the method which precedes time t₀, a first logic instruction value commands the actuator to remain inactive, in other words, to leave dog clutch couplers 51 and 52 separated.

Curve 102 represents a control mode digital signal of the electrical machine 42. In the initial step of the method which precedes time t₀, this digital signal corresponds with an inert state of the electrical machine 42. In other words, the electrical machine is not supplied with electrical current.

Curve 103 represents a torque instruction signal of the electrical machine 42 which is non-functional during the initial step of the method.

Curve 104 represents a speed instruction signal of the electrical machine 42, also non-functional during the initial step which precedes time t₀, during which the electrical machine is inert.

Curve 105 represents a signal generated by the position sensor 32. As previously said, in the initial step which precedes time t₀, coupling mechanism 43 is disconnected, which is indicated by a low signal value of the curve 105.

Curve 106 represents the speed of the wheels 44 at the dog clutch coupler 52. In the initial step which precedes time t₀, whereby the vehicle is moving, a rise of curve 106 denotes, for instance, a vehicle in acceleration phase. The goal of the method is to allow for coupling regardless of the speed variations of the vehicle during the whole coupling phase.

Curve 107 represents the speed of the electrical machine 42 at dog clutch coupler 51, in other words, taking into account the gear ratio of gear box 45. In the initial step of the method which precedes time t₀, the electrical machine 42 is for instance in zero speed state.

Curve 108 represents the effective state of the coupling mechanism which is not necessarily translated into a measurement signal or a command signal, but which can correspond with an internal variable of a program employing the method for qualifying the different states that the coupling mechanism goes through during the coupling phase.

At time t₀ when a coupling request is received, the method enters a controlled phase during which the electronic device verifies whether the coupling mechanism 43 is connected or disconnected. In other words, the electronic device verifies whether the position sensor indicates a connected or disconnected position of dog clutch couplers 51 and 52. If the coupling mechanism is disconnected, the method leaves the control step at time t1 to enter in a speed control phase of the electrical machine. In the controlled phase between times t₀ and t₁, the logic instruction of the position of actuator 34 remains at its previous logic value as can be seen on curve 101. Actuator 34 remains inactive.

As can be seen on curve 102, the electrical machine remains inert and the speed of wheels 44 continues to evolve respective to the speed of the vehicle as indicated on curve 106.

In the speed control phase of the electrical machine, starting from time t1, the control mode digital signal of electrical machine 42 assumes the distinctive value of speed control mode. The speed control mode of electrical machine 42 includes regulating the speed of the rotor of the electrical machine. In known manner, the speed servo control of the electrical machine comprises a first step which generates a torque instruction to be supplied to the electrical machine in order to annul the speed gap between the rotor speed instruction and the rotor speed measurement received in return. The torque instruction generated by the first step is applied as input to a second step which supplies the electrical machine with a current, which is proportional to the torque, in known manner. The torque generated in this way imposes to the electrical machine a rotational speed equal to the instruction. In the speed control step of the electrical machine, the speed instruction signal of the electrical machine, as indicated by curve 104, follows the wheel speed as indicated by curve 106. In other words, if the vehicle is in acceleration phase, the speed instruction of the electrical machine increases and any slowdown provokes a consequent inflexion of curve 104. The second servo control step of the electrical machine is only limited by the current absorption capacity of the electrical machine. The supply current of the electrical machine which is then at maximum absorption capacity in order to annul the speed gaps between instruction and return measurement, provokes a speed increase of the electrical machine, uniformly accelerated to catch up, by multiplying it with the gear ratio, with the speed corresponding with the wheel speed. This phenomenon is translated into the slope of curve 107 between time t₁ and t₂ when curve 106 of the wheel speed changes into a high speed value.

When the speed gap 110 between the wheel speed reported on curve 106 and the speed of the electrical machine, scaled taking into account the gear ratio, to be reported on curve 107, is smaller than a predetermined threshold, a time delay is launched which ends at time t₂. Both the predetermined threshold and the time delay can be calibrated. The speed gap threshold is determined in such manner as to allow for the engagement without slippage of the upstream dog clutch coupler with the downstream dog clutch coupler. As an indication of the magnitude, taking into account the inaccuracy of the measurements, a value of twenty revolutions per minute is acceptable. The goal of the time delay is to ensure that the speed gap has dropped below the threshold in stable manner, in other words, that the crossing of the threshold is not of untimely nature. For instance, the value of the time delay can be initiated at 50 ms and then adjusted in order to obtain optimum functionality. Other ways are available for obtaining this functionality, for instance by placing a time constant filter with the time delay value on the measured speed gap at the input of the first servo control phase of the electrical machine.

At time t₂, the method leaves the speed control step of the electrical machine and enters in a torque control step of the electrical machine. The digital signal of the control mode of the electrical machine 42 changes value as can be seen on curve 102. The value change of the control mode digital signal acts on the servo control of the electrical machine, especially in the second phase which determines the real value of the current passing through the electrical machine, which is proportional to the torque. A current limiting function at the input of the second servo control phase is lowered to a value corresponding with the torque instruction of the electrical machine. The electrical current instruction generated by the speed step is then saturated at the current limit. The limit value is calculated in such a manner as to compensate the inertial torque corresponding with the maximum potential acceleration of the vehicle. As a non-limiting illustrative example, this value is defined in a tolerance range of 2 Nm to take into account the various uncertainties of the torque. The peripheral speed loop obtained by the first servo control step ensures that the electrical machine is not starting at over-speed in case the limit torque is greater than the torque necessary for simply maintaining the speed. The torque instruction of the electrical machine applied to the current limit can be variable as can be seen on curve 103.

Simultaneously with the change in the value of the control mode digital signal of the electrical machine 42 at time t₂ on curve 102, the logic position instruction of actuator 34 changes value as can be seen on curve 101 to make the actuator enter active mode. Actuator 34 then moves the mobile dog clutch coupler 52 from the disconnected position, in which it was at time t₂, to a connected position t₃, noted on curve 108. Between times t₂ and t₃, the position of the dog clutch couplers is uncertain as shown by curve 105. The time value t₃-t₂ can be predetermined by taking into account the displacement stroke of the mobile dog clutch coupler and the force of the actuator. It may not be necessary to know the value of time t₃. Indeed, the connected or disconnected position is detected by the position of the dog clutch coupler actuator and is controlled by the zero speed gap. Beyond time t₃, the coupling mechanism is in a connected position as indicated by curve 105 and the electrical machine is connected with the wheels as indicated on curve 108. The coupling process is completed.

In economic terms, the exploitation of the torque control and speed control possibilities of the electrical machine, associated with a simplified actuator, and controlled in simple manner in on-or-off mode, allows for a significant reduction of the cost relative to more complex systems.

Although the invention is described in connection with a specific implementation mode, it is evident that the invention is not limited to it, and that numerous variants and modifications are possible without exceeding the scope or intent of the invention. Specifically, the electrical powertrain group can be mounted both in the front and in the rear of the vehicle, on a drive axle which is identical or different from the drive axle that the thermal powertrain is mounted on. Although not shown on FIG. 2, a gear box can also be placed between the upstream dog clutch coupler and the wheels. The displacement of the downstream dog clutch coupler can be replaced by the displacement of the upstream dog clutch coupler.

1. A method for connecting an electrical machine with the wheels of the drive axle of a vehicle when the vehicle is moving, comprising the steps of:
controlling the speed of the electrical machine, in which a rotational speed instruction is applied to the electrical machine in order to reduce the gap between the speed of an upstream dog clutch coupler, which rotates together with the electrical machine, and the speed of a downstream dog clutch coupler, which rotates together with the wheels; and
coupling which is activated following a speed gap smaller than a predetermined threshold, in which the electrical machine is servo controlled based on a torque instruction and dog clutch couplers are brought closer together until a coupled state is obtained of the two dog clutch couplers.

2. A method for connecting according to claim 1, wherein the torque instruction is limited to a compensation of the inertial torque corresponding with the maximum potential acceleration of the vehicle.

3. A method according to claim 1, wherein the speed instruction is based on the value of the wheel speed.

4. A method according to claim 1 wherein coupling is activated when the speed gap remains smaller than a predetermined threshold during a time delay.

5. A system for coupling an electrical machine with the wheels of a drive axle of a vehicle when the vehicle is moving, comprising:
an upstream dog clutch coupler rotating together with the electrical machine, a downstream dog clutch coupler rotating together with the wheels and an actuator arranged for bringing the two dog clutch couplers together in translation along a common rotation axis; and
an electronic device arranged for receiving a coupling request, and for speed control of the electrical machine by applying to it a rotational speed instruction in order to reduce the gap between the speed of upstream dog clutch coupler and the speed of downstream dog clutch coupler, and for servo control of the electrical machine based on a torque instruction, and for bringing dog clutch couplers closer together until the coupled state of the two dog clutch couplers is obtained.

6. The system for coupling according to claim 5, wherein the torque instruction is limited to compensation of the inertial torque corresponding with the maximum potential acceleration of the vehicle.

7. The system for coupling according to claim 5, wherein the speed instruction is based on the value of the wheel speed.

8. The system for coupling according to claim 5, wherein the electronic device comprises a memorized time delay to verify that the speed gap remains smaller than the predetermined threshold during said time delay.

9. An automotive vehicle comprising a system according to one of claim 5 to execute the method according to claim 1.
